(19) United States
(12) Patent Application Publication
(10) Pub. No.: US 2015/0186956 A1
(43) Pub. Date: Jul. 2, 2015

(54) Method of Promoting Customer Loyalty and Charitable Donations by Adjusting a Sale Transaction Subtotal by Executing Computer-Executable Instructions Stored On a Non-Transitory Computer-Readable Medium

(71) Applicant: Andrew S. Gordon, Hopewell, NJ (US)

(72) Inventor: Andrew S. Gordon, Hopewell, NJ (US)

(21) Appl. No.: 14/551,494

(22) Filed: Nov. 24, 2014

Related U.S. Application Data
(60) Provisional application No. 61/921,161, filed on Dec. 27, 2013.

(51) Int. Cl. G06Q 30/02; G06Q 20/20; G06Q 20/10

(52) U.S. Cl. CPC G06Q 30/0279; G06Q 20/10; G06Q 30/0222; G06Q 20/20

(57) ABSTRACT

A method of promoting customer loyalty and charitable donations by adjusting a sale transaction subtotal prompts customers to transfer small amounts of money to one of a variety of accounts. The customer is prompted to add an adjustment amount to their transaction, and choose where to send the adjustment amount. If the customer pays with cash, the adjustment amount is the customer's change. If the customer pays with an electronic payment, the adjustment amount is the difference between the subtotal and the next dollar amount, or a different pre-set amount. The customer then chooses whether to deposit the adjustment amount into a customer rewards account, donate the adjustment amount to a charity of their choice, or tip the employee.

The current application claims a priority to the U.S. Provisional Patent application Ser. No. 61/921,161 filed on Dec. 27, 2013.

### FIELD OF THE INVENTION

The present invention relates generally to monetary transactions. More particularly, the present invention relates to promoting charitable donations and customer loyalty to a business.

### BACKGROUND OF THE INVENTION

The practice of charity means the voluntary giving of help to those in need. Charitable giving is the act of giving money, goods or time to the unfortunate, either directly or by means of a charitable trust of another worthy cause. In the past century, many charitable organizations have created a “charitable model” in which donators give to conglomerates, which in turn pass on the donations to recipients. A charitable organization is a type of non-profit organization that centers on non-profit and philanthropic goals as well as social well-being serving the public interest or common good. Charitable organizations often depend partly on donations from for-profit organizations or individuals. Examples of charitable organizations include the Make a Wish Foundation, the American Cancer Society, and the World Wildlife Fund. Charitable organizations utilize their funds to further philanthropic goals, and the more funds a charitable organization has at its disposal, the more effectively the goals are accomplished. Individuals tend to go through their lives without being substantially aware of or participating in charitable efforts, and it is desirable to augment the engagement of the everyday person in such efforts.

It is desirable for businesses to retain customers in order to maximize their profits. Strategic management is often employed by businesses to foster customer loyalty in order to accomplish this goal. One such means of customer loyalty is to provide customers with rewards and incentives for repeatedly engaging in transactions with the business, such as discounts on future purchases or other benefits.

It is therefore an object of the present invention to provide a method for fostering charitable donations and customer loyalty to a business through asking customers for small additional amounts of money at point of sale transaction.

### BRIEF DESCRIPTION OF THE DRAWINGS

FIG. 1 is a stepwise flow diagram describing the general process of the present invention.

FIG. 2 is a stepwise flow diagram describing the process for choosing where to transfer the adjustment amount.

FIG. 3 is a stepwise flow diagram describing operations for identifying a customer and storing transaction history for the customer in the database.

FIG. 4 is a stepwise flow diagram describing operations for adjusting the sale transaction.

FIG. 5 is an example screen on a POS terminal showing options for adjusting the transaction subtotal.

FIG. 6 is an example screen on a POS terminal showing options for utilizing the customer reward account.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a method for promoting charitable donations and customer loyalty by adjusting a sale transaction subtotal at a point of sale (POS) terminal. The present invention is carried out by executing computer-executable instructions stored on a non-transitory computer-readable medium, such as, but not limited to, a computing device such as a point of sale terminal, a personal computer, a mobile device such as a smartphone or tablet, or any other electronic device which may facilitate the execution of the present invention.

The intent of the present invention is primarily to foster customer loyalty to a business. This intention is achieved by the present invention in two ways: firstly, the present invention presents a means for customers to make a charitable donation with each purchase. The charitable donations may be tracked over time, and the customer may benefit by documenting their charitable donations through filing for tax deductions, or other benefits may result as well. For example, the business may choose to provide the customer with discounts, coupons or other rewards based on their donation history. The secondary intention of the present invention is to provide the customer with a loyalty reward system. Instead of donating to charity, the customer may choose to deposit a small sum into a rewards account, which can be utilized to reduce the cost of future purchases. The customer is also provided with an option to tip the employee running the point of sale terminal.

In order to function, the present invention requires a system comprising a database or other storage device, a processing unit, and a digital network for communicating among various entities such as banks or other monetary handling or other financial services, the business's servers and other digital infrastructure such as is typically utilized by a business. The process of the present invention is carried out by the aforementioned system.

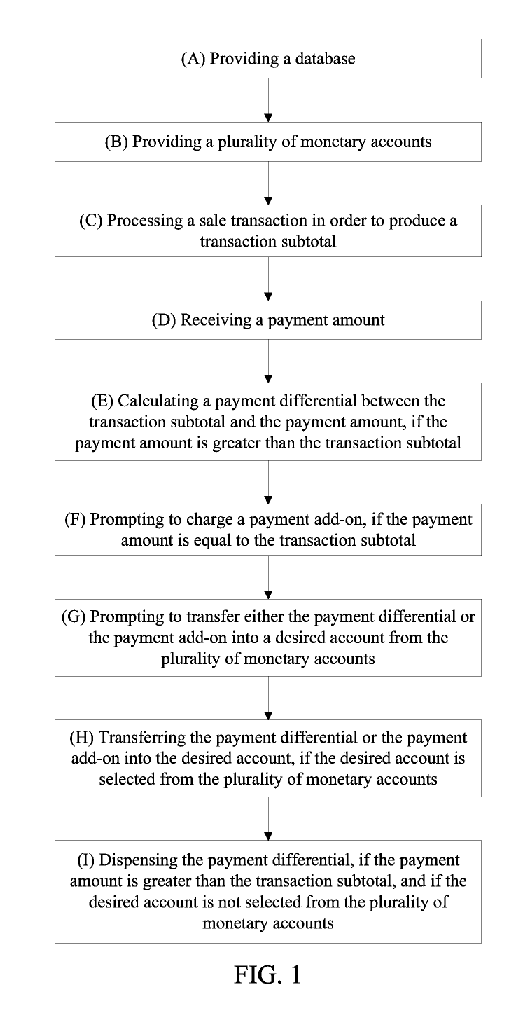

In reference to FIG. 1, a database and a plurality of monetary accounts are provided. The plurality of monetary accounts may include, but are not limited to, a customer account, a plurality of charity accounts, and an employee account. Each of the plurality of monetary accounts may be associated with or operated by a bank, a business, a charity, or another relevant entity. Any information related to the monetary accounts is stored on and accessed through any appropriate means, preferably on a secure digital network or any other means currently or potentially utilized to operate, access and protect such accounts.

A sale transaction is processed in order to produce a transaction subtotal, which is the sum of the prices of each item the customer wishes to purchase. The transaction subtotal may also include tax, if applicable. A payment amount is then received from the customer. The payment amount reflects the monetary amount provided by the customer in order to purchase their items and is either equal to or greater than the transaction subtotal. The next step in the process is determined by what medium of payment the customer provides.

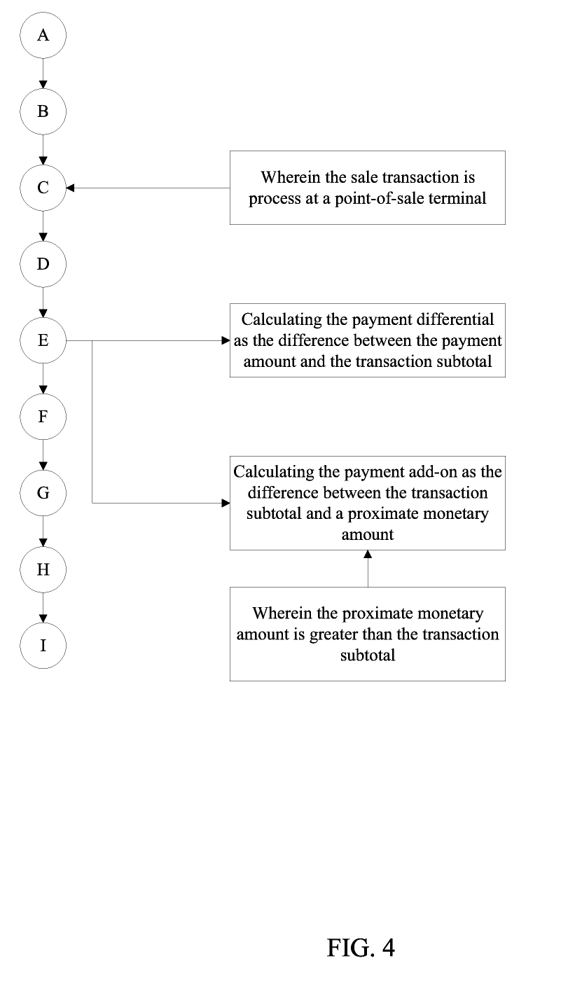

Referring to FIG. 4, if the customer is paying with physical tender (cash), a payment differential is calculated between the transaction subtotal and the payment amount. This case may also be described as the payment amount being greater than the transaction subtotal. In this case, the payment differential is calculated as the difference between the payment amount and the transaction subtotal. For example, if the transaction subtotal is $5.65, and the customer provides a payment amount of $6, the payment differential is then $0.35.

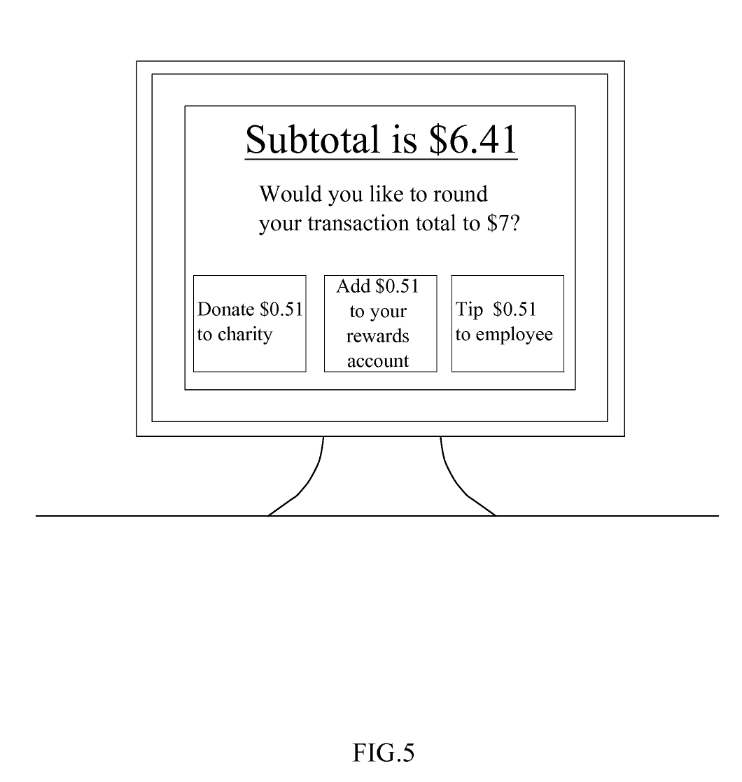

If the customer wishes to pay with a credit card or another means of electronic payment, and therefore the payment amount to be received is equal to the transaction subtotal, the customer is prompted to additionally charge a payment add-on. In this case, the payment add-on is calculated as the difference between the transaction subtotal and a proximate monetary amount, wherein the proximate monetary amount is greater than the transaction subtotal. In the preferred embodiment of the present invention, the proximate monetary amount is the next highest even dollar amount. For example, if the transaction subtotal is $5.65, the proximate monetary amount is therefore $6, and the add-on amount is $0.35. Both the payment differential and the payment add-on may also hereinafter be referred to as an adjustment amount. The adjustment amount (payment differential for cash, add-on amount for credit) is the primary focus of the present invention, with the customer being prompted to either donate the adjustment amount to charity, store the adjustment amount in the customer account for later use, or tip the employee operating the POS terminal, as illustrated in FIG. 5.

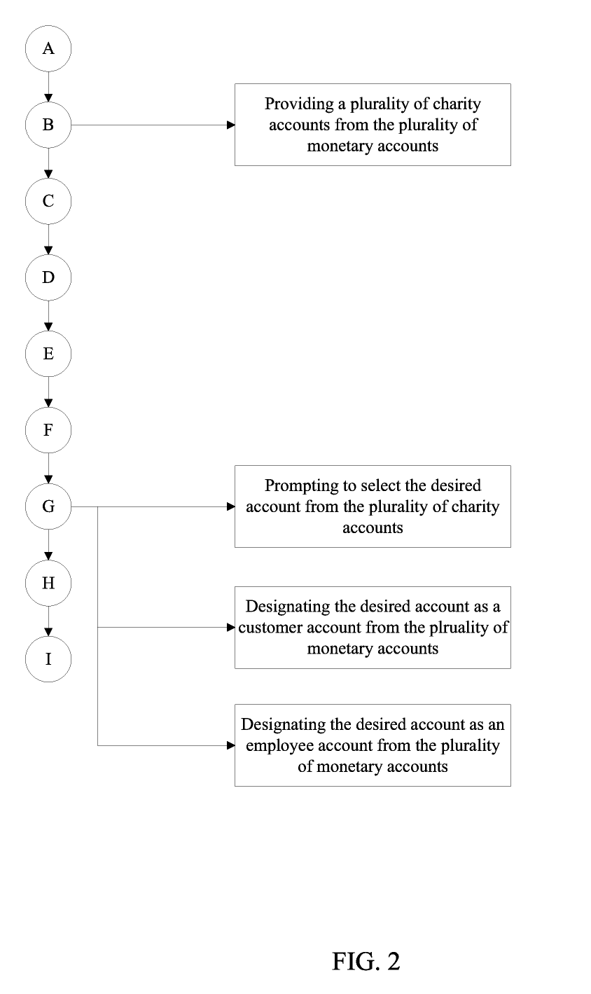

Referring to FIG. 2, the customer is then prompted to transfer either the payment differential (if the customer is paying with cash) or the payment add-on (if the customer is using an electronic payment means) into a desired account from the plurality of monetary accounts. If the customer chooses to participate in the process of the present invention, the customer selects the desired account from the plurality of monetary accounts. The desired account may be the customer account, one of the charity accounts, or the employee account. If the desired account is selected from the plurality of monetary accounts, the payment differential is transferred into the desired account. If the customer pays with cash and does not wish to participate in the process of the present invention and select the desired account, the payment differential is dispensed as physical money (bills and coins) and returned to the customer.

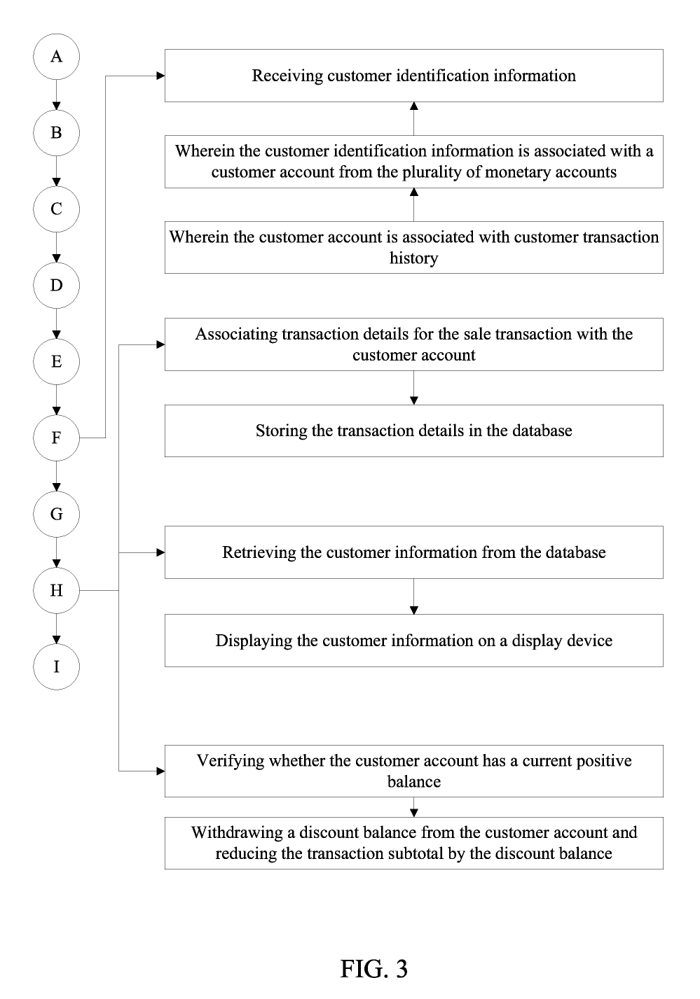

Referring to FIG. 3, in order for the present invention to foster customer loyalty, records must be kept for the customer and means for the customer to be identified must be provided. When the sale transaction is processed, the employee operating the point of sale terminal verifies whether the customer has a customer account with the business. If the customer does have a customer account with the business, the customer must provide customer identification information in order to be identified, which is received through the point of sale terminal. The customer identification information is associated with a customer account from the plurality of monetary accounts. The customer identification information may be stored on or retrieved by any number of applicable methods. For example, the customer may be identified by providing a phone number, email address, or PIN. Other means for customer identification may include, but are not limited to, scanning a barcode or QR code, swiping a magnetic strip card, scanning a fingerprint, scanning a radio frequency identification (RFID) chip, or by utilizing wireless communication from a smart phone or other electronic mobile device. Such wireless communication means may include, but are not limited to, near-field communication (NFC), Bluetooth, or wi-fi communication, or another type of wireless radio frequency communication.

In the preferred embodiment of the present invention, the present invention allows for the option of a customer to make a donation to a charitable organization without requiring a customer account to be registered in the database. However, the primary focus is on customers who have registered an account, so that the customer is incentivized to return to the place of business through the benefits provided by the present invention.

In the preferred embodiment of the present invention, the customer is provided with three different options for where to transfer the adjustment amount, as shown in FIG. 5.

Firstly, the customer may donate to a charitable organization. Upon deciding to donate to a charitable organization, the customer is provided with a list of several charitable organizations from which to choose. If the customer opts to donate the adjustment amount to charity, the customer is then prompted to select the desired account from the plurality of charity accounts. Once the charity account is selected, the adjustment amount is transferred into the charity account. Subsequently, transaction details for the sale transaction are associated with the customer account, and the transaction details are stored in the database, if the customer has an account registered in the database and if the customer identification information has been received in order to identify the customer.

Secondly, the customer may deposit the adjustment amount into the customer account. In this case, a selection for the desired account is received in order to designate the desired account as the customer account. In one embodiment of the present invention, the customer may be presented with the option to deposit an additional amount into the customer account in addition to the adjustment amount.

Thirdly, the customer may choose to tip the employee. In this case, a selection for the desired account is received in order to designate the desired account as an employee account from the plurality of monetary accounts. The employee is subsequently able to withdraw the adjustment amount from the employee account for their personal use.

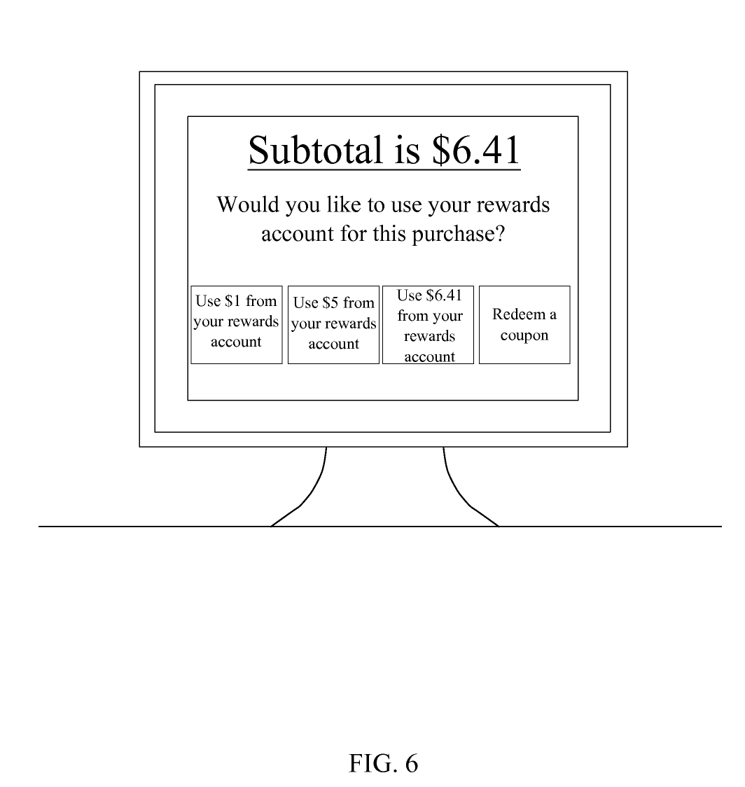

In the preferred embodiment of the present invention, the customer account may be utilized by the customer to reduce the cost of a purchase, as shown in FIGS. 3 and 6. This scenario requires that the customer has previously registered the customer account and deposited a balance into the customer account through the process of the present invention. Once the transaction subtotal is calculated and the customer identification information is received, a subtotal reduction decision is received through the point of sale terminal. The customer account is then verified to have a current positive balance. If the customer account does have a current positive balance, a discount balance is withdrawn from the customer account, and the transaction subtotal is reduced by the discount balance. The discount balance may be a portion of the transaction subtotal, such as an even dollar amount or a percentage of the transaction subtotal, or the discount balance may be equal to the transaction subtotal, or the customer may specify a specific value for the discount balance the customer wishes to apply to the transaction subtotal. Alternatively, the business may designate a specific discount amount that the customer is allowed to utilize for any given purchase.

In the preferred embodiment of the present invention, the customer is able to view information regarding previous transactions. Preferably, this is provided through a website interface and a display device such as a computer. The customer enters their customer identification information on a website affiliated with the business in order to log in to their account. The customer information is then retrieved from the database and displayed on a display device. Examples of customer information may include, but are not limited to, transaction history, current account balance, and available coupons or other rewards. The customer information is also able to be viewed from the business' end. An administrator for the business may access the customer information through a computing device, and may manually review the customer account and choose to confer rewards to the customer account, such as adding to the balance of the customer account, or offering a coupon or other benefit to the customer account.

Although the invention has been explained in relation to its preferred embodiment, it is to be understood that many other possible modifications and variations can be made without departing from the spirit and scope of the invention as hereinafter claimed.

What is claimed is:

1. A method of promoting customer loyalty and charitable donations by adjusting a sale transaction subtotal by executing computer-executable instructions stored on a non-transitory computer-readable medium comprises the steps of:
providing a database;
providing a plurality of monetary accounts;
processing a sale transaction in order to produce a transaction subtotal;
receiving a payment amount;
calculating a payment differential between the transaction subtotal and the payment amount, if the payment amount is greater than the transaction subtotal;
prompting to charge a payment add-on, if the payment amount is equal to the transaction subtotal;
prompting to transfer either the payment differential or the payment add-on into a desired account from the plurality of monetary accounts;
transferring the payment differential or the payment add-on into the desired account, if the desired account is selected from the plurality of monetary accounts; and
dispensing the payment differential, if the payment amount is greater than the transaction subtotal, and if the desired account is not selected from the plurality of monetary accounts.

2. A method of promoting customer loyalty and charitable donations by adjusting a sale transaction subtotal by executing computer-executable instructions stored on a non-transitory computer-readable medium as claimed in claim 1 comprises the step of:
providing a plurality of charity accounts from the plurality of monetary accounts; and
prompting to select the desired account from the plurality of charity accounts.

3. A method of promoting customer loyalty and charitable donations by adjusting a sale transaction subtotal by executing computer-executable instructions stored on a non-transitory computer-readable medium as claimed in claim 1 comprises the step of:
designating the desired account as a customer account from the plurality of monetary accounts.

4. A method of promoting customer loyalty and charitable donations by adjusting a sale transaction subtotal by executing computer-executable instructions stored on a non-transitory computer-readable medium as claimed in claim 1 comprises the step of:
designating the desired account as an employee account from the plurality of monetary accounts.

5. A method of promoting customer loyalty and charitable donations by adjusting a sale transaction subtotal by executing computer-executable instructions stored on a non-transitory computer-readable medium as claimed in claim 1 comprises the step of:
receiving customer identification information,
wherein the customer identification information is associated with a customer account from the plurality of monetary accounts; and
wherein the customer account is associated with customer transaction history.

6. A method of promoting customer loyalty and charitable donations by adjusting a sale transaction subtotal by executing computer-executable instructions stored on a non-transitory computer-readable medium as claimed in claim 5 comprises the steps of:
associating transaction details for the sale transaction with the customer account, wherein the customer transaction history comprises the transaction details; and
storing the transaction details in the database.

7. A method of promoting customer loyalty and charitable donations by adjusting a sale transaction subtotal by executing computer-executable instructions stored on a non-transitory computer-readable medium as claimed in claim 5 comprises the steps of:
retrieving the customer information from the database; and
displaying the customer information on a display device;.

8. A method of promoting customer loyalty and charitable donations by adjusting a sale transaction subtotal by executing computer-executable instructions stored on a non-transitory computer-readable medium as claimed in claim 5 comprises the steps of:
verifying whether the customer account has a current positive balance; and
withdrawing a discount balance from the customer account and reducing the transaction subtotal by the discount balance, if the customer account has a current positive balance.

9. A method of promoting customer loyalty and charitable donations by adjusting a sale transaction subtotal by executing computer-executable instructions stored on a non-transitory computer-readable medium as claimed in claim 1, wherein the sale transaction is processed at a point-of-sale (POS) terminal.

10. A method of promoting customer loyalty and charitable donations by adjusting a sale transaction subtotal at a point of sale terminal by executing computer-executable instructions stored on a non-transitory computer-readable medium as claimed in claim 1 comprises the step of:
calculating the payment differential as the difference between the payment amount and the transaction subtotal.

11. A method of promoting customer loyalty and charitable donations by adjusting a sale transaction subtotal by executing computer-executable instructions stored on a non-transitory computer-readable medium as claimed in claim 1 comprises the step of:
calculating the payment add-on as the difference between the transaction subtotal and a proximate monetary amount, wherein the proximate monetary amount is greater than the transaction subtotal.
